(19) United States
(12) Patent Application Publication
(10) Pub. No.: US 2026/0128231 A1
(43) Pub. Date: May 7, 2026

(54) MULTILAYER CERAMIC CAPACITOR

(71) Applicant: Murata Manufacturing Co., Ltd., Nagaokakyo-shi (JP)

(72) Inventors: Sadayuki KOIZUMI, Nagaokakyo-shi (JP); Tetsuya KISUMI, Nagaokakyo-shi (JP)

(21) Appl. No.: 19/440,994

(22) Filed: Jan. 6, 2026

Related U.S. Application Data
(63) Continuation of application No. PCT/JP2024/017925, filed on May 15, 2024.

(30) Foreign Application Priority Data
Jul. 18, 2023 (JP) 2023-116993

(51) Int. Cl. H01G 4/30; H01G 4/232

(52) U.S. Cl. CPC H01G 4/30; H01G 4/2325

(57) ABSTRACT

A multilayer ceramic capacitor includes a ceramic body including six surfaces including main surfaces, side surfaces, and end surfaces, and external electrodes on the ceramic body and connected to some of internal electrode layers. The external electrodes include glass domains. In a longitudinal direction, a ratio of a sum of lengths, in a longitudinal direction, of the glass domains to a sum of lengths of a surface of an electrode arrangement portion on at least one of the side surfaces and the main surfaces, and of a surface of a corner portion contiguous with the surface of the electrode arrangement portion is about 40% to about 60%, and a ratio of a number of glass domains extending from a surface of the ceramic body to a surface of the external electrode located in the electrode arrangement portion is about 10% to about 30%.

### CROSS REFERENCE TO RELATED APPLICATIONS

This application claims the benefit of priority to Japanese Patent Application No. 2023-116993 filed on Jul. 18, 2023 and is a Continuation Application of PCT Application No. PCT/JP2024/017925 filed on May 15, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In the process of forming external electrodes of multilayer ceramic capacitors, blisters may be formed in the external electrodes. Blisters are cavities formed inside the external electrodes. When blisters are formed in the external electrodes, problems such as reduced electrical conductivity of the external electrodes or reduced reliability of the external electrodes may occur. Regarding methods for reducing blisters, Japanese Unexamined Patent Application, Publication No. H04-95307 describes adjusting the material composition of external electrodes.

However, in the conventional technology, the reduction or prevention of blister occurrence is not sufficient.

### SUMMARY OF THE INVENTION

Example embodiments of the present invention provide multilayer ceramic capacitors that are each able to more reliably reduce or prevent blisters.

An example embodiment of the present invention provides a multilayer ceramic capacitor which includes a ceramic base body including a plurality of dielectric layers and a plurality of internal electrode layers that are laminated, and six surfaces including a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction, and external electrodes on the ceramic base body and each connected to some of the plurality of internal electrode layers. When a portion, among the six surfaces of the ceramic base body, where any of the external electrodes is provided is defined as an electrode placement portion, and when a portion, in the ceramic base body, where two of the six surfaces intersect is defined as a corner portion, the external electrodes include glass domains, a ratio of a sum of lengths in the length direction of the glass domains relative to a sum of lengths in the length direction of a surface of the ceramic base body in the electrode placement portion on at least one surface among the first lateral surface, the second lateral surface, the first main surface, and the second main surface and a surface of the ceramic base body in the corner portion continuous to the at least one surface in the length direction is about 40% or more and about 60% or less, and among the glass domains provided in the electrode placement portion, a ratio of a number of glass domains extending from the at least one surface of the ceramic base body to a corresponding one of surfaces of the external electrodes is about 10% or more and about 30% or less.

According to example embodiments of the present invention, multilayer ceramic capacitors that are each able to more reliably reduce or prevent blisters are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to an example embodiment of the present invention.

FIG. 2 is a cross-sectional view taken along the line I-I in FIG. 1.

FIG. 3 is a cross-sectional view taken along the line II-II in FIG. 1.

FIG. 4 is an enlarged view of a portion enclosed by a frame in FIG. 2.

FIG. 5 is an LT cross-sectional view showing the arrangement of glass domains.

FIG. 6 is an LT cross-sectional view showing the electrically conductive paste after application and drying.

FIG. 7 is an LT cross-sectional view showing the electrically conductive paste after firing.

FIG. 8 is a three-dimensional focused ion beam scanning electron microscope image of an external electrode.

### DETAILED DESCRIPTION OF THE EXAMPLE EMBODIMENTS

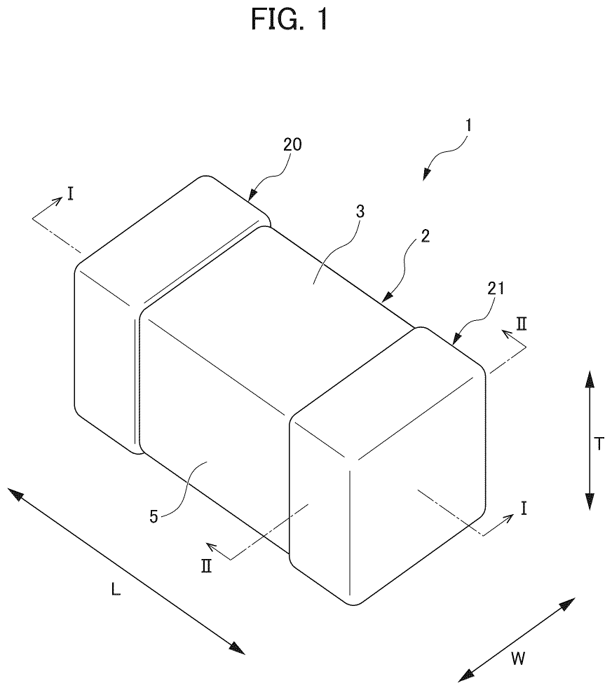

Example embodiments of the present invention will be described in detail below with reference to the drawings. FIG. 1 is a perspective view of a multilayer ceramic capacitor 1 according to an example embodiment of the present invention. FIG. 1 shows a two-terminal multilayer ceramic capacitor. The multilayer ceramic capacitors according to example embodiments of the present invention are not limited to two-terminal multilayer ceramic capacitors. The multilayer ceramic capacitors according to example embodiments of the present invention may be multi-terminal multilayer ceramic capacitors such as three-terminal capacitors, for example.

The multilayer ceramic capacitor 1 according to an example embodiment of the present invention includes a ceramic base body 2 and terminal electrodes. The terminal electrodes include a first terminal electrode 20 and a second terminal electrode 21.

The ceramic base body 2 includes a plurality of laminated dielectric layers and a plurality of laminated internal electrode layers. The ceramic base body 2 has a rectangular or substantially rectangular parallelepiped shape.

In the ceramic base body 2, a direction in which the dielectric layers and the internal electrode layers are laminated is defined as a height direction T. A direction orthogonal or substantially orthogonal to the height direction T is defined as a width direction W. A direction orthogonal or substantially orthogonal to the height direction T and the width direction W is defined as a length direction L.

In the ceramic base body 2, one of the two surfaces opposed to each other in the height direction T is defined as a first main surface 3. The other one is defined as a second main surface 4. In the ceramic base body 2, one of the two surfaces opposed to each other in the width direction W is defined as a first lateral surface 5. The other one is defined as a second lateral surface 6. In the ceramic base body 2, one of the two surfaces opposed to each other in the length direction L is defined as a first end surface 7. The other one is defined as a second end surface 8.

With respect to the cross section of the ceramic base body 2, the cross section along the line I-I in FIG. 1 is referred to as the LT cross section. With respect to the cross section of the ceramic base body 2, the cross section along the line II-II in FIG. 1 is referred to as the WT cross section.

A portion where three surfaces of the ceramic base body 2 intersect is referred to as a corner edge of the ceramic base body 2. A portion where two surfaces of the ceramic base body 2 intersect is referred to as a ridge portion or corner portion of the ceramic base body 2. It is preferable that the corner edges and the ridge portions are rounded.

The total number of dielectric layers laminated in the ceramic base body 2 is, for example, preferably fifteen or more and 2000 or less. The main material of the dielectric layers is a ceramic material. Examples of the ceramic material include dielectric ceramics including barium titanate, calcium titanate, strontium titanate, calcium zirconate, or the like as a main component. The ceramic material may be a dielectric ceramic in which sub-components such as, for example, manganese compounds, iron compounds, chromium compounds, cobalt compounds, nickel compounds, or the like are added to these main components.

The thickness of each dielectric layer is, for example, preferably about 0.3 μm or more and about 10 μm or less.

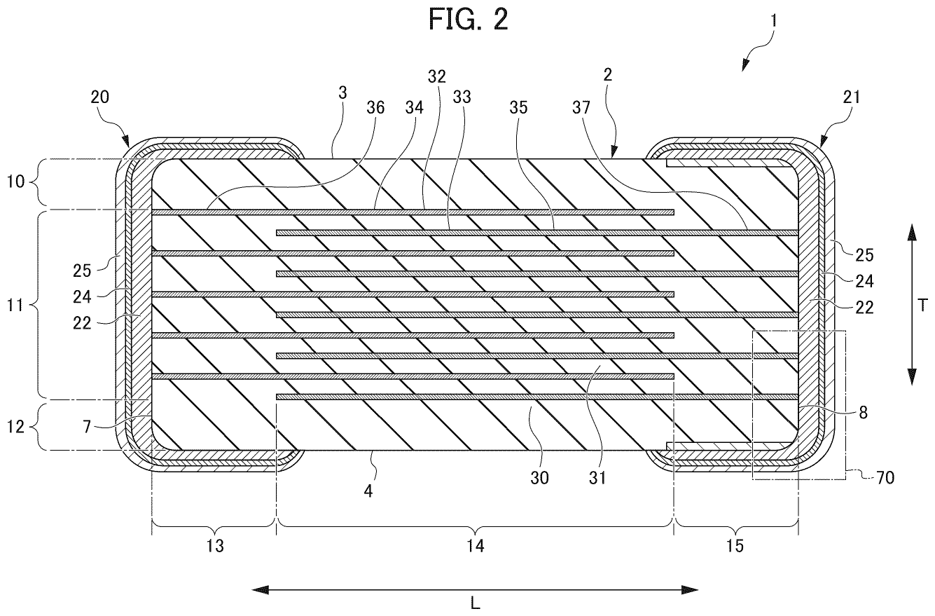

The divisions of the ceramic base body 2 in the length direction L will be described based on FIG. 2. FIG. 2 is a cross-sectional view taken along the line I-I in FIG. 1. The ceramic base body 2 can be divided into a first main surface-side outer layer portion 10, an effective portion 11, and a second main surface-side outer layer portion 12 in the height direction T.

The first main surface-side outer layer portion 10 is a portion between an internal electrode layer closest to the first main surface 3 and the first main surface 3. The effective portion 11 is a portion where the internal electrode layers are opposed to each other. The second main surface-side outer layer portion 12 is a portion between an internal electrode layer closest to the second main surface 4 and the second main surface 4.

Among the dielectric layers, the dielectric layers provided in the first main surface-side outer layer portion 10 and the second main surface-side outer layer portion 12 are defined as outer dielectric layers 30. Among the dielectric layers, the dielectric layers provided in the effective portion 11 are defined as inner dielectric layers 31.

The size of the ceramic base body 2 is not particularly limited. The dimension in the length direction L of the ceramic base body is, for example, preferably about 0.2 mm or more and about 10 mm or less. The dimension in the width direction W of the ceramic base body 2 is, for example, preferably about 0.1 mm or more and about 5 mm or less. The dimension in the height direction T of the ceramic base body 2 is, for example, preferably about 0.1 mm or more and about 5 mm or less.

The divisions of the ceramic base body 2 in the length direction L will be explained. The ceramic base body 2 can be divided into a first end surface-side outer layer portion 13, a length direction counter portion 14, and a second end surface-side outer layer portion 15 in the length direction L.

The length direction counter portion 14 refers to a portion where the internal electrode layers are opposed to each other in the height direction T. The first end surface-side outer layer portion 13 refers to a portion between the length direction counter portion 14 and the first end surface 7. The second end surface-side outer layer portion 15 refers to a portion between the length direction counter portion 14 and the second end surface 8.

The length direction counter portion 14 corresponds to the counter electrode portions of the internal electrode layers. The first end surface-side outer layer portion 13 and the second end surface-side outer layer portion 15 correspond to extension electrode portions of the internal electrode layers. The first end surface-side outer layer portion 13 and the second end surface-side outer layer portion 15 are also referred to as L gaps.

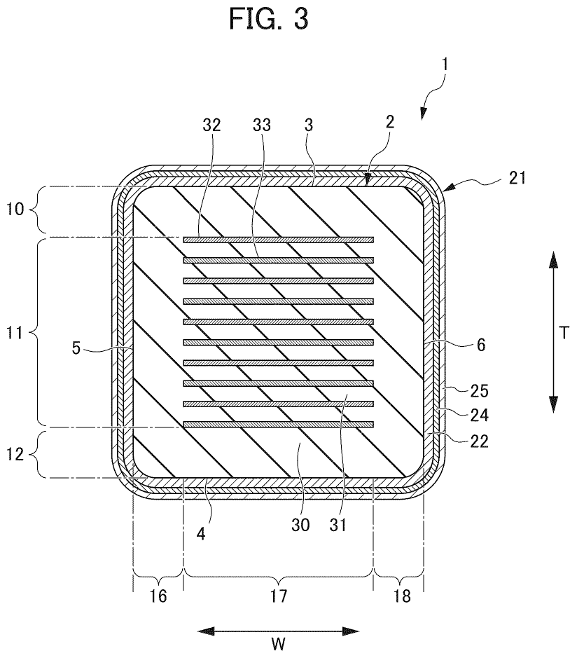

The divisions of the ceramic base body 2 in the width direction W will be described based on FIG. 3. FIG. 3 is a cross-sectional view taken along the line II-II in FIG. 1. The ceramic base body 2 can be divided into a first lateral surface-side outer layer portion 16, a width direction counter portion 17, and a second lateral surface-side outer layer portion 18 in the width direction W.

The width direction counter portion 17 refers to a portion where the internal electrode layers are opposed to each other in the height direction T. The first lateral surface-side outer layer portion 16 refers to a portion between the width direction counter portion 17 and the first lateral surface 5. The second lateral surface-side outer layer portion 18 refers to a portion between the width direction counter portion 17 and the second lateral surface 6.

The first lateral surface-side outer layer portion 16 and the second lateral surface-side outer layer portion 18 are portions where no internal electrode layers exist in the height direction T. The first lateral surface-side outer layer portion 16 and the second lateral surface-side outer layer portion 18 are also referred to as W gaps.

The internal electrode layers include a plurality of first internal electrode layers 32 and a plurality of second internal electrode layers 33. The first internal electrode layers 32 are exposed at the first end surface 7. The second internal electrode layers 33 are exposed at the second end surface 8.

Each of the first internal electrode layers 32 can be divided into a first counter electrode portion 34 and a first extension electrode portion 36. The first counter electrode portion 34 refers to a portion opposed to a corresponding one of the second internal electrode layers 33. The first extension electrode portion 36 refers to a portion extending from the first counter electrode portion 34 toward the first end surface 7 of the ceramic base body 2.

Each of the second internal electrode layers 33 can be divided into the second counter electrode portion 35 and the second extension electrode portion 37. The second counter electrode portion 35 is a portion that is opposed to a corresponding one of the first internal electrode layers 32. The second extension electrode portion 37 is a portion that extends from the second counter electrode portion 35 toward the second end surface 8 of the ceramic base body 2.

The material of the internal electrode layers can be, for example, a metal such as nickel, copper, silver, palladium, or gold. The material of the internal electrode layers can be an alloy including at least one of the above-described metals, such as a silver-palladium alloy, for example.

In the multilayer ceramic capacitor 1, capacitance is generated by the first counter electrode portion 34 and the second counter electrode portion 35 opposing each other with a corresponding one of the inner dielectric layers 31 interposed therebetween. This enables the multilayer ceramic capacitor 1 to provide capacitor characteristics.

The thickness of each of the internal electrode layers is preferably about 0.2 μm or more and about 2.0 μm or less, for example. The total number of the first internal electrode layers 32 and the second internal electrode layers 33 is, for example, preferably fifteen or more and 2000 or less.

The terminal electrodes will be described. The terminal electrodes include a first terminal electrode 20 and a second terminal electrode 21. The first terminal electrode 20 is a terminal electrode connected to the first internal electrode layers 32. The second terminal electrode 21 is a terminal electrode connected to the second internal electrode layers 33.

The first terminal electrode 20 is provided on the first end surface 7, a portion of the first main surface 3, a portion of the second main surface 4, a portion of the first lateral surface 5, and a portion of the second lateral surface 6. The second terminal electrode 21 is provided on the second end surface 8, a portion of the first main surface 3, a portion of the second main surface 4, a portion of the first lateral surface 5, and a portion of the second lateral surface 6.

The terminal electrodes each include, for example, an external electrode 22, a nickel plating film 24, and a tin plating film 25. These are provided in the order of the external electrode 22, the nickel plating film 24, and the tin plating film 25 from the end surface of the ceramic base body 2.

The external electrode 22 is provided on the end surface of the ceramic base body 2, and covers the end surface. The external electrode 22 extends from the end surface to a portion of the main surfaces and a portion of the lateral surfaces.

The external electrode 22 includes glass and metal. The glass includes at least one of, for example, boron, silicon, barium, magnesium, aluminum, lithium, or the like. The metal includes at least one of, for example, copper, nickel, silver, palladium, silver-palladium alloy, gold, or the like. The external electrodes 22 are each formed by applying an electrically conductive paste including glass and metal to the ceramic base body 2, and firing the resulting product. The metal is included in the electrically conductive paste as metal powder. The glass is included in the electrically conductive paste as glass powder. The thickness of the external electrode 22 is preferably, for example, about 3 μm or more and about 25 μm or less. The external electrodes 22 will be described later.

The nickel plating film 24 covers the external electrodes 22. The tin plating film 25 covers the nickel plating film 24.

The nickel plating film 24 can prevent the external electrode 22 from being eroded by solder when mounting the multilayer ceramic capacitor 1. The tin plating film 25 can improve the wettability of solder when mounting the multilayer ceramic capacitor 1, and facilitate mounting.

The size of the multilayer ceramic capacitor 1 is not particularly limited. The preferred dimension in the length direction of the multilayer ceramic capacitor 1 including the ceramic base body 2 and the terminal electrodes is, for example, about 0.2 mm or more and about 10 mm or less. The preferred dimension in the height direction of the multilayer ceramic capacitor 1 including the ceramic base body 2 and the terminal electrodes is, for example, about 0.1 mm or more and about 5 mm or less. The preferred dimension in the width direction of the multilayer ceramic capacitor 1 including the ceramic base body 2 and the terminal electrodes is, for example, about 0.1 mm or more and about 10 mm or less.

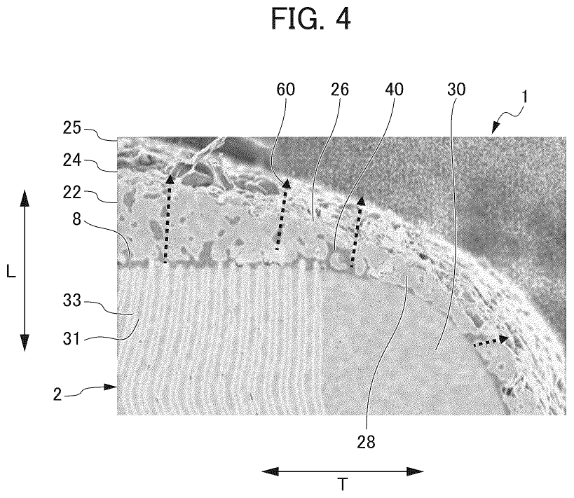

The external electrodes 22 will be described in more detail. FIG. 4 is an enlarged view of a portion indicated by the frame 70 in FIG. 2. The external electrode 22 includes a metal domain 28 and glass domains 40. The metal domain 28 is a region formed by metal included in the electrically conductive paste after firing. Each of the glass domains 40 is a region formed by glass included in the electrically conductive paste after firing.

A surface of the external electrode 22 facing the nickel plated film 24 is defined as a surface 26. At least a portion of the glass domains 40 extends from the surface of the ceramic base body 2 to the surface 26 of the external electrode 22 in the external electrode 22. The glass domains 40 define and function as degassing paths when firing the electrically conductive paste. Each of the degassing paths is a path for allowing gas produced when firing the electrically conductive paste to escape to the outside of the external electrode 22. Arrows 60 shown in FIG. 4 each show an example of the degassing path. By forming the degassing paths 60, gas is less likely to remain inside the external electrode 22 when firing the electrically conductive paste. As a result, blisters are less likely to be produced in the external electrode 22.

In the multilayer ceramic capacitor 1 of the present example embodiment, an occupancy ratio of the glass domains 40 on the surface of the ceramic base body 2 included in a portion where the external electrode 22 is provided on at least one surface among the first lateral surface 5, the second lateral surface 6, the first main surface 3, and the second main surface 4, and a corner portion continuous to the surface in the length direction is, for example, about 40% or more and about 60% or less. This will be described based on the drawings. Further, the portion where the external electrode 22 is provided among the first lateral surface 5, the second lateral surface 6, the first main surface 3, and the second main surface 4 is referred to as an electrode placement portion.

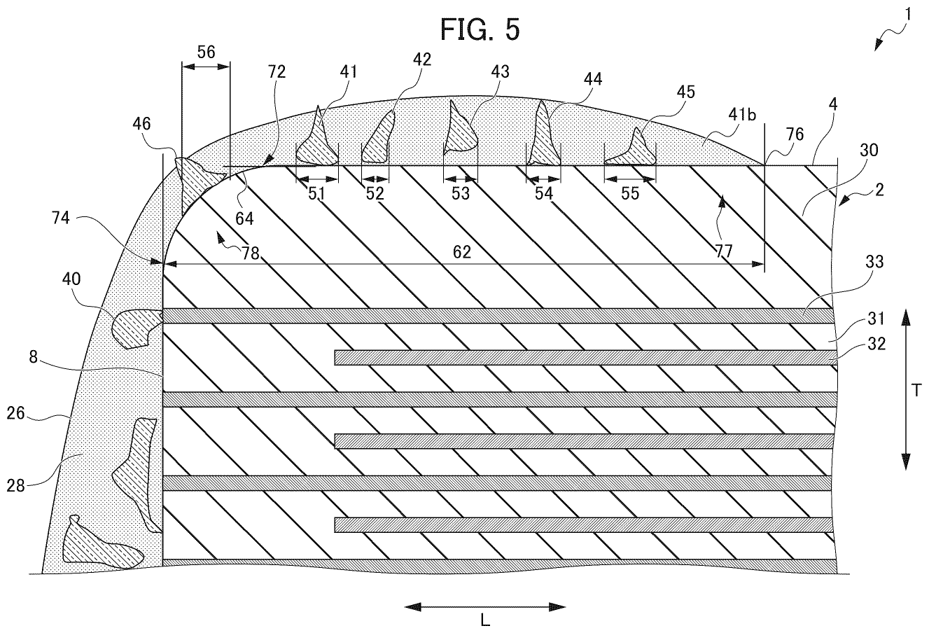

FIG. 5 is a conceptual diagram for explaining the arrangement of the glass domains 40. FIG. 5 shows an LT cross section of the multilayer ceramic capacitor 1. FIG. 5 shows the second main surface 4 and the second end surface 8. The contents described below are the same or substantially the same for the other surfaces.

A position 72 in FIG. 5 is a position where the second main surface 4 starts to slope toward the second end surface 8. A position 74 in FIG. 5 is a position where the second end surface 8 starts to slope toward the second main surface 4. A portion from the position 72 to the position 74 in the ceramic base body 2 is defined as a corner portion 78.

A position 76 in FIG. 5 is a position of an end portion of the external electrode 22 on the second main surface 4. A range from the position 72 to the position 76 is defined as an electrode placement portion 77.

A sum of a length in the length direction L of the surface of the ceramic base body 2 in the electrode placement portion 77 and a length in the length direction L of the surface 64 of the ceramic base body 2 in the corner portion 78 is defined as a length 62. That is, in the example shown in FIG. 5, the length 62 is a linear length in the length direction L from the position 76 of the end portion of the external electrode 22 on the second main surface 4 to the second end surface 8.

On the second main surface 4, five glass domains from a first glass domain 41 to a fifth glass domain 45 are provided. Further, a sixth glass domain 46 is provided in the corner portion 78. Lengths in the length direction L of the respective glass domains are indicated by lengths 51 to 56.

Here, a ratio of a sum of the lengths 51 to 56 relative to the length 62 is obtained. In the present example embodiment, for example, this ratio is about 40% or more and about 60% or less. This indicates that an occupancy ratio of glass on the surface of the ceramic base body 2 at the corner and the lateral surface or the main surface is about 40% or more and about 60% or less.

In addition, in the multilayer ceramic capacitor 1 of the present example embodiment, the ratio of the number of glass domains 40 extending from the surface of the ceramic base body 2 to the surface 26 of the external electrode 22, among the glass domains 40 provided in the electrode placement portion 77, is, for example, about 10% or more and about 30% or less. In the example shown in FIG. 5, five glass domains from the first glass domain 41 to the fifth glass domain 45 are provided in the electrode placement portion 77. Among these, the first glass domain 41 extends from the surface of the ceramic base body 2 to the surface 26 of the external electrode 22. That is, among the five glass domains, one glass domain extends from the surface of the ceramic base body 2 to the surface 26 of the external electrode 22. The ratio is, for example, about 20%.

In this manner, when the glass occupancy ratio is about 40% or more and about 60% or less, and the ratio of the glass domains 40 including a glass extending in a columnar shape to the surface 26 of the external electrode 22 is about 10% or more and about 30% or less, it is possible to reduce or prevent the formation of blisters in the external electrode 22 when firing the electrically conductive paste.

In particular, it is possible to reduce or prevent the occurrence of blisters in the corner portion 78 where the film thickness of the external electrode 22 is thin and blisters are likely to occur.

An example of a method for forming such glass domains 40 will be shown and described below. First, there is a method of blending two or more types of metal powders having different particle sizes and particle shapes into the electrically conductive paste. For example, copper powder having a D50 average particle size of about 1 μm and a spherical particle shape, and copper powder having a D50 average particle size of about 4 μm and a flat particle shape are blended into the electrically conductive paste. The flat-shaped copper powder defines and functions as a beam, making it possible to provide a degassing path and to form the columnar glass domains 40.

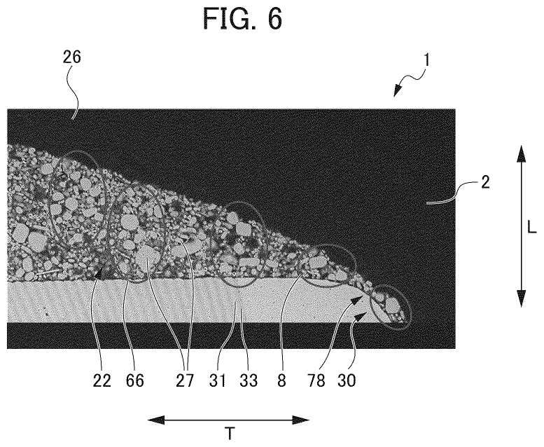

FIG. 6 is a diagram showing a state after applying the electrically conductive paste for the external electrode 22 to the ceramic base body 2, and allowing it to dry. FIG. 6 shows a portion of the LT cross section of the multilayer ceramic capacitor 1. As shown in the circle 66 in FIG. 6, among the metal powders 27, there is a portion where a plurality of flat-shaped metal powders 27 are continuous in the thickness direction of the electrically conductive paste from the surface of the ceramic base body 2. This portion provides a degassing path when firing the electrically conductive paste. By connecting the flat-shaped metal powders 27 having large particle sizes, they define and function as beams and secure a path in the thickness direction.

In addition, in the corner portion 78, only one flat-shaped metal powder 27 exists in the film thickness direction. A degassing path is provided around this single metal powder 27.

When blending two or more types of metal powders having different particle sizes into the electrically conductive paste, the particle sizes of the metal powders are not limited to the above-described about 1 μm and about 4 μm. For example, they can be appropriately changed to about 1.2 μm and about 3.6 μm.

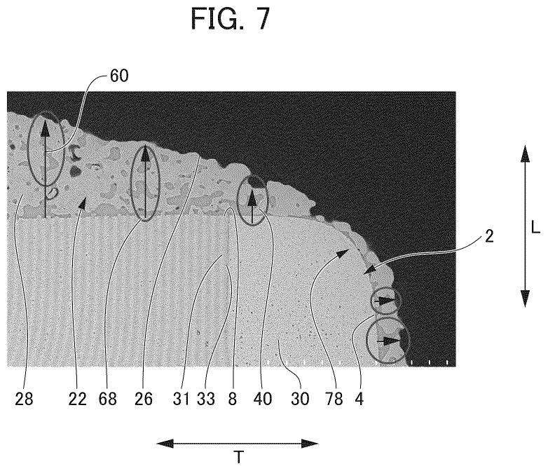

Based on FIG. 7, the state of the electrically conductive paste after firing will be described. FIG. 7 is a diagram showing the electrically conductive paste after firing. FIG. 7 shows a portion of the LT cross section of the multilayer ceramic capacitor 1, similarly to FIG. 6.

As shown in the circle 68 in FIG. 7, a continuous portion is formed where the glass domain 40 extends from the surface of the ceramic base body 2 toward the surface of the external electrode 22. This portion defines and functions as the degassing path 60.

The degassing path 60 is formed not only on the second end surface 8, but also on the second main surface 4. Although not shown in FIG. 7, the degassing path 60 is similarly formed on the other surfaces of the ceramic base body 2.

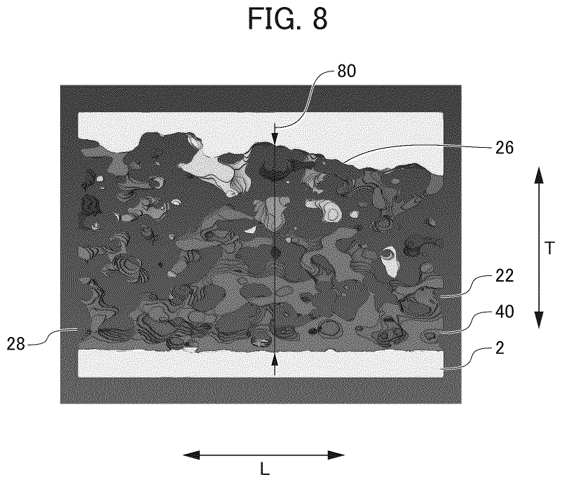

In FIG. 7, there are portions where the glass domains 40 are interrupted between the surface of the ceramic base body 2 and the surface of the external electrode 22. This is because FIG. 7 shows only one cross section. As will be described later based on FIG. 8, the glass domains 40 have a three-dimensional spread. In other words, the glass domains 40 form a three-dimensional network. Therefore, even when the glass domains 40 are interrupted on the plane of FIG. 7, the glass domains 40 are connected on the front side or the back side of the plane.

An example of a method of blending two or more types of metal powders having different particle sizes and shapes into the electrically conductive paste has been described as a method for forming the glass domains 40. In addition to using such metal powders, columnar glass domains 40 are more easily formed by making the softening point of the glass higher than the necking initiation temperature due to surface diffusion between the fine-particle-side metal powders among the two types of metal powders. This is because, by advancing necking between the metal powders faster than the glass softens to form cavities, the glass will tend to migrate toward the surface 26 of the external electrode 22. The firing temperature can be, for example, about 650° C. or more and about 950° C. or less.

Also, it is preferred that the flatness of the flat-shaped copper powder is lower. The flatness of the flat-shaped copper powder can be, for example, about 1.05 or more and about 2 or less.

Also, it is preferred that the particle size of the glass particles blended into the electrically conductive paste is smaller. The D50 average particle size of the glass particles can be, for example, about 0.5 μm or more and about 2.2 μm or less, and preferably about 0.5 μm or more and about 1.0 μm or less.

Also, it is preferred that the ratio of the particle size of the glass particles to the particle size of the flat-shaped copper powder is larger. For example, the ratio of the D50 average particle size of the glass particles to the D50 average particle size of the flat-shaped copper powder can be about 1 or more and about 4 or less.

The three-dimensional configuration of the glass domains 40 will be described based on FIG. 8. FIG. 8 is a 3D-FIB (Focused Ion Beam)-SEM (Scanning Electron Microscope) image of the external electrode 22 in the LT cross section. SEM images of continuous cross sections connected together are shown in one image. The striped patterns shown in one glass domain 40 in FIG. 8 each indicate glass domains 40 observed in different cross sections on the back side of the plane.

As shown in FIG. 8, the glass domains 40 extend not only in the plane, but also to the back side of the plane, forming a three-dimensional network.

In the external electrode 22 of the present example embodiment, in the external electrode 22 provided on at least one of the first lateral surface 5, the second lateral surface 6, the first main surface 3, or the second main surface 4, the glass domains 40 occupy, for example, about two-thirds or more of the length of the external electrode 22 in the film thickness direction.

Here, “occupying about two-thirds or more of the length in the film thickness direction” indicates that, when it is determined that glass domains 40 exist at a film thickness position, if the glass domains 40 exist at any position on a plane perpendicular or substantially perpendicular to the film thickness direction within the external electrode 22, the glass domains 40 exist at positions corresponding to at least about two-thirds of the length of the external electrode 22 in the film thickness direction. That is, the positions where glass domains 40 exist at that film thickness position correspond to about two-thirds or more of the film thickness.

An example of a method for measuring the length and thickness of each portion will be described. The multilayer ceramic capacitor 1 is polished to the middle position in the width direction W. Then, the LT cross section exposed by polishing is observed with an optical microscope or the like. From the observed LT cross section, the length or thickness can be measured.

An example of a method for manufacturing the multilayer ceramic capacitor 1 will be described. First, dielectric sheets and electrically conductive paste for manufacturing internal electrode layers are prepared. The dielectric sheets and the electrically conductive paste for manufacturing internal electrode layers include a binder and a solvent. The binder and the solvent may be a known organic binder and organic solvent.

The electrically conductive paste for manufacturing internal electrode layers is printed on the dielectric sheet in a predetermined pattern. The internal electrode layer pattern is formed by printing the electrically conductive paste. The printing can be performed by, for example, screen printing or gravure printing.

A predetermined number of dielectric sheets for manufacturing the outer layer portion are laminated. No internal electrode layer pattern is printed on the dielectric sheets for manufacturing the outer layer portion. Dielectric sheets with printed internal electrode layer patterns are sequentially laminated on the laminated dielectric sheets. Furthermore, a predetermined number of dielectric sheets for manufacturing the outer layer portion are laminated thereon. A multilayer sheet is produced by these lamination processes.

The multilayer sheet is pressed in the height direction to produce a multilayer block. The pressing method can be, for example, hydrostatic pressing.

The multilayer block is cut to a predetermined size. Multilayer chips are cut out by this cutting. The corner edges and ridge portions of each of the multilayer chips may be rounded during cutting. Barrel polishing, for example, can be used for the method for rounding.

The multilayer chips are fired. Ceramic base bodies are manufactured by this firing. The preferred firing temperature is, for example, about 900° C. or more and about 1110° C. or less. The firing temperature can be changed according to the materials of the dielectric and the internal electrode layer.

Terminal electrodes are formed. First, electrically conductive paste that will define and function as the external electrode 22 is applied to the two end surfaces of the ceramic base body 2. The electrically conductive paste includes glass and metal. The electrically conductive paste can be applied by methods such as dipping, for example. After application, firing is performed to form the external electrode 22. The firing temperature is, for example, preferably about 500° C. or more and about 900° C. or less. Further, the firing time is, for example, preferably about 30 minutes or more and about 2 hours or less.

A nickel plating film 24 is formed on the surface of the external electrode 22. Furthermore, a tin plating film 25 is formed on the surface of the nickel plating film 24. The nickel plating film 24 and the tin plating film 25 can be formed by, for example, a barrel plating method or the like. In this way, the multilayer ceramic capacitor 1 can be manufactured.

Although example embodiments of the present invention have been described above, the present invention is not limited thereto, and various changes and modifications are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a ceramic base body including a plurality of dielectric layers and a plurality of internal electrode layers that are laminated, and six surfaces including a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction; and
external electrodes on the ceramic base body and each connected to some of the plurality of internal electrode layers; wherein
when a portion, among the six surfaces of the ceramic base body, where any of the external electrodes is provided is defined as an electrode placement portion, and, when a portion, in the ceramic base body, where two of the six surfaces intersect is defined as a corner portion, the external electrodes include glass domains;
a ratio of a sum of lengths in the length direction of the glass domains relative to a sum of lengths in the length direction of a surface of the ceramic base body in the electrode placement portion on at least one surface among the first lateral surface, the second lateral surface, the first main surface, and the second main surface and a surface of the ceramic base body in the corner portion continuous to the at least one surface in the length direction is about 40% or more and about 60% or less; and
among the glass domains provided in the electrode placement portion, a ratio of a number of glass domains extending from the at least one surface of the ceramic base body to a corresponding one of surfaces of the external electrodes is about 10% or more and about 30% or less.

2. The multilayer ceramic capacitor according to claim 1, wherein, in one of the external electrodes provided on at least one of the first lateral surface, the second lateral surface, the first main surface, and the second main surface, the glass domains occupy about two-thirds or more of a length in a film thickness direction of the one of the external electrodes.

3. The multilayer ceramic capacitor according to claim 1, wherein each of the external electrodes includes a metal domain.

4. The multilayer ceramic capacitor according to claim 3, wherein the metal domain includes at least one of copper, nickel, silver, palladium, silver-palladium alloy, or gold.

5. The multilayer ceramic capacitor according to claim 1, wherein the glass domains include at least one of boron, silicon, barium, magnesium, aluminum, or lithium.

6. The multilayer ceramic capacitor according to claim 1, wherein the ratio of the number of glass domains extending from the at least one surface of the ceramic base body to a corresponding one of surfaces of the external electrodes is about 20%.

7. The multilayer ceramic capacitor according to claim 1, wherein the glass domains include copper powder having a D50 average particle size of about 1 μm and a spherical particle shape, and copper powder having a D50 average particle size of about 4 μm and a flat particle shape.

8. The multilayer ceramic capacitor according to claim 1, wherein the glass domains include glass particles having a D50 average particle size of about 0.5 μm or more and about 2.2 μm or less.

9. The multilayer ceramic capacitor according to claim 1, wherein the glass domains include glass particles having a D50 average particle size of about 0.5 μm or more and about 1.0 μm or less.

10. The multilayer ceramic capacitor according to claim 1, further comprising a nickel plating film on each of the external electrodes and a tin plating layer on the nickel plating layer.

11. The multilayer ceramic capacitor according to claim 1, wherein a thickness of each of the external electrode layers is about 3 μm or more and about 25 μm or less.

12. The multilayer ceramic capacitor according to claim 1, wherein a thickness of each of the plurality of dielectric layers is about 0.3 μm or more and about 10 μm or less.
